(19) United States
(12) Patent Application Publication
(10) Pub. No.: US 2015/0355733 A1
(43) Pub. Date: Dec. 10, 2015

(54) INPUT DEVICE AND COMPUTER SYSTEM WITH OPERATING PATTERN ANALYSIS

(71) Applicant: PIXART IMAGING INC., Hsin-Chu County (TW)

(72) Inventors: YEN-MIN CHANG, HSIN-CHU COUNTY (TW); CHUN-WEI CHEN, HSIN-CHU COUNTY (TW)

(21) Appl. No.: 14/828,716

(22) Filed: Aug. 18, 2015

Related U.S. Application Data
(63) Continuation-in-part of application No. 14/299,099, filed on Jun. 9, 2014.

(30) Foreign Application Priority Data
Jul. 16, 2013 (TW) 102125502

(51) Int. Cl. G06F 3/0354

(52) U.S. Cl. CPC G06F 3/03543

(57) ABSTRACT

There is provided an input device including at least one input unit, a trigger detection unit, a storage unit and an analysis and processing unit. The at least one input unit is for inputting a plurality of trigger events by a user. The trigger detection unit is configured to detect the trigger events of the at least one input unit and generate a trigger signal corresponding to each of the trigger events. The storage unit is configured to record an operating condition associated with the user. The analysis and processing unit is configured to analyze an operating pattern of the trigger signals and determine a warning time according to the operating condition and the operating pattern.

### CROSS REFERENCE TO RELATED APPLICATION

The present application is a continuation-in-part application of U.S. Ser. No. 14/299,099, filed on Jun. 9, 2014, currently pending, the disclosure of which is hereby incorporated by reference herein in its entirety.

### BACKGROUND

1. Field of the Disclosure

This disclosure generally relates to an input device and, more particularly, to an input device and a computer system with operating pattern analysis and capable of giving a fatigue warning.

2. Description of the Related Art

In the present days, almost all of the document processing, including the drawing, statistics and editing can be performed by using the computer system. Meanwhile, the indoor entertainment can also gradually be implemented by using the computer system to execute game programs or application software. Accordingly, the time that the user spends on operating the computer system is becoming longer and longer to cause a higher burden to the user's body. However, the long-time operation can degrade the working efficiency and even more affect the health of the user.

The conventional computer system and the peripheral devices thereof can only have unidirectional response to the use's operation. As the user generally does not pay attention to the operating interval when focusing on operation, the overtime operation is always a problem. However, current computer systems do not employ any device or application software that can analyze the operating interval suitable for different users according to the personal use habits.

Accordingly, the present disclosure further provides an input device and a computer system with operating pattern analysis that may analyze the user's operating pattern under different conditions and give a fatigue warning at a proper time so as to prevent the long-time operation.

### SUMMARY

The present disclosure provides an input device and a computer system that may record and update pattern thresholds associated with different operating conditions to be served as the reference for giving a warning.

The present disclosure further provides an input device and a computer system that may record and update pattern thresholds associated with different operating conditions and determine an adaptive warning time through analyzing the operating pattern.

The present disclosure further provides an input device and a computer system that may give a warning at an adaptive warning time or inhibit the triggering of the input device.

The present disclosure provides a mouse device including at least one mouse button, a mouse roller, a memory and a processor. The at least one mouse button is configured to generate a click signal when being operated. The mouse roller is configured to generate a rolling signal when being operated. The memory is configured to store an operating condition. The processor is configured to analyze an operating pattern of a plurality of click signals and a plurality of rolling signals to determine an operating strain, determine a strain threshold according to the operating condition, and decrease a mouse DPI when the operating strain exceeds the strain threshold.

The present disclosure provides a computer system including a mouse device, a display device and a computer host. The mouse device includes at least one mouse button, a mouse roller, a memory, a processor and a communication interface. The at least one mouse button is configured to generate a click signal when being operated. The mouse roller is configured to generate a rolling signal when being operated. The memory is configured to store an operating condition. The processor is configured to analyze an operating pattern of a plurality of click signals and a plurality of rolling signals to determine an operating strain, determine a strain threshold according to the operating condition, and generate a warning signal when the operating strain exceeds the strain threshold. The communication interface is configured to output the warning signal. The display device is configured to show a cursor. The computer host is coupled to the mouse device via the communication interface and coupled to the display device via a video interface. The computer host is configured to decrease a movement resolution of the cursor shown on the display device when receiving the warning signal.

The present disclosure provides a computer system including a mouse device, a display device and a computer host. The mouse device includes at least one mouse button, a mouse roller, a memory, a processor and a communication interface. The at least one mouse button is configured to generate a click signal when being operated. The mouse roller is configured to generate a rolling signal when being operated. The processor is configured to analyze an operating pattern of a plurality of click signals and a plurality of rolling signals. The communication interface is configured to output the operating pattern. The display device is configured to show a cursor. The computer host is coupled to the mouse device via the communication interface and coupled to the display device via a video interface. The computer host is configured to determine an operating strain according to the received operating pattern, determine a strain threshold according to an operating condition, and decrease a movement resolution of the cursor shown on the display device when the operating strain exceeds the strain threshold.

In one aspect, the input device may be a computer peripheral device such as a mouse, a keyboard, a joystick or a touch pad.

In one aspect, different operating conditions may include, for example, different operating hours, different operating locations, different user IDs, different terminal devices, different application software and/or different operating states. The input device or computer system may determine a pattern threshold according to the above operating conditions and analyze an operating pattern of the user, wherein the operating pattern may include, for example, an accumulated number, an operating interval, an accumulated displacement, an average speed, an operating frequency and/or a pressing pressure. The pattern threshold may include, for example, an accumulated number threshold, an accumulated interval threshold and an accumulated displacement threshold. For example, when different users operate the same application software or terminal device at the same hour and location, as the operating pattern is different, different pattern thresholds may be obtained. When the same user operates different application software (e.g. document processing software, drawing software, game software) or different terminal devices (e.g. portable devices, fixed devices, game devices) at different hours (e.g. daytime, night) and different locations (e.g. home, office, school), as the operating pattern is different, different pattern thresholds may be obtained. In addition, the input device or computer system may further adjust and update the pattern threshold according to the operating pattern, e.g. adjusting the determined pattern threshold and updating the operating state according to the parameter indicating the operating strength, e.g. an average speed, an operating frequency and/or a pressing pressure.

In one aspect, the input device may perform the communication with a host using wired or wireless communication so as to output the detected results and analyzed results.

In one aspect, the input device may further include a data storage module to also have the function of flash disk and may perform the data access through wired method (e.g. USB interface) or wireless method (e.g. Bluetooth).

In one aspect, the input device may output the trigger signal, e.g. displacement, with an adjustable report rate, wherein the report rate may be selected by a user him/herself or determined automatically according to a current running program of the host. For example, the report rate may be decreased in operating document processing software so as to reduce the power consumption.

In one aspect, the input device may have the function of physiological detection. For example, it is able to recognize different user identifications (IDs) by detecting the pulse, fingerprint and operating track of the user or to automatically access information of the operating condition and operating pattern associated with a current user from the storage unit.

In one aspect, the input device may include a microphone and/or a speaker configured to play the sound effect, perform the telephone conference and give a prompt sound.

The input device with operating mode analysis according to the embodiment of the present disclosure may be implemented by software or hardware.

In the input device and computer system according to the embodiment of the present disclosure, when the analysis and processing unit analyzes that the current operating pattern has satisfied the warning condition, the input device itself may directly give a warning or the warning may be generated by the host or other peripheral devices coupled to the host. For example, the input device itself or the host may generate a warning sound, a warning light or a vibration or inhibit the output or slow down the output to be served as a way to give the warning; or the host may control a screen device to directly show a specific message or picture to be served as a way to give the warning.

### BRIEF DESCRIPTION OF THE DRAWINGS

Other objects, advantages, and novel features of the present disclosure will become more apparent from the following detailed description when taken in conjunction with the accompanying drawings.

FIG. 1 shows an operational schematic diagram of the computer system according to an embodiment of the present disclosure.

FIG. 2 shows a schematic block diagram of the computer system according to an embodiment of the present disclosure.

FIG. 3 shows another schematic block diagram of the computer system according to an embodiment of the present disclosure.

FIG. 4 shows another schematic block diagram of the computer system according to an embodiment of the present disclosure.

FIG. 5 shows a flow chart of the operation of the input device and the computer system according to the embodiment of the present disclosure.

FIGS. 6A and 6B show operational schematic diagrams of the input device and the computer system according to the embodiment of the present disclosure.

### DETAILED DESCRIPTION OF THE EMBODIMENT

It should be noted that, wherever possible, the same reference numbers will be used throughout the drawings to refer to the same or like parts.

The computer system with operating pattern analysis according to the embodiment of the present disclosure includes an input device and a host, wherein the input device may be a computer peripheral device such as a mouse device, a joystick device, a keyboard or a touchpad and is configured to output a trigger signal to the host. The host then executes application software or controls an electronic device according to the trigger signal, e.g. controlling a screen to show a corresponding operation. The method that different input devices output the trigger signal to a host for performing the corresponding control is well known and thus details thereof are not described herein. The spirit of the present disclosure is that the input device or the computer system may further give a warning at an adaptive warning time according to a current operating condition and a current operating pattern of the user so as to remind the user to prevent the long-time use, wherein the term “adaptive” is referred to that the operating condition may be trained according to the user's operating pattern so as to form a personal operating condition, e.g. updating the pattern threshold corresponding to the operating condition according to an accumulated triggering number, an accumulated operating interval, an accumulated displacement and an operating strength each time operated by the user.

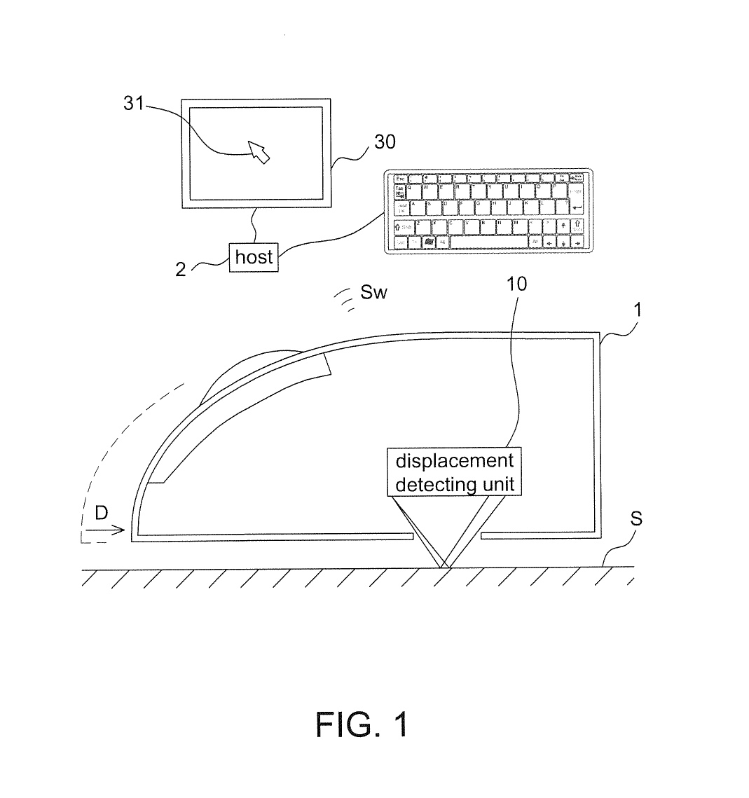

For example, when the input device 1 is a mouse device, the input device 1 may be configured to detect a displacement D with respect to a work surface S (e.g. FIG. 1 showing a displacement detection unit 10 configured to detect the displacement D). The input device 1 may further output a warning signal Sw at an adaptive warning time according to a current operating condition and an operating pattern. The host 2 may control a cursor 31 shown by a display device 3 according to the displacement D and generate a warning according to the warning signal Sw. In addition, when the input device 1 is other peripheral devices, the host 2 may execute corresponding operations according to the trigger signals of different peripheral devices and generate a warning according to the warning signal Sw.

In the embodiment of the present disclosure, the current operating condition may include an operating hour, an operating location, a user ID, a terminal device, application software and/or an operating state. More specifically speaking, different pattern thresholds may be determined when the current operating condition is different, wherein the pattern threshold may include an accumulated number threshold (e.g. including a clicking number and a rolling number of the mouse roller), an accumulated interval threshold (e.g. the total accumulated operating interval before an accumulated non-operating interval exceeding a predetermined time interval), and an accumulated displacement threshold (e.g. the accumulated displacement detected by the mouse device or touch pad). Different pattern thresholds may be set according to different operating hours, e.g. a higher pattern threshold for daytime and a lower pattern threshold for nighttime. Different pattern thresholds may be set according to different operating locations, e.g. a higher pattern threshold for office and a lower pattern threshold for home. Different pattern thresholds may be set according to different user IDs, e.g. a higher pattern threshold for adults and a lower pattern threshold for kids. Different pattern thresholds may be set according to different terminal devices, e.g. a higher pattern threshold for table computers and a lower pattern threshold for game machines. Different pattern thresholds may be set according to different application software, e.g. a higher pattern threshold for document processing software and a lower pattern threshold for game software. Different pattern thresholds may be set according to different operating states, e.g. a lower pattern threshold for stronger historical operating strength (e.g. including the average speed, operating frequency and/or pressing pressure) and a higher pattern threshold for weaker historical operating strength. It should be mentioned that the above methods of setting high/low of the pattern threshold are only exemplary and the pattern threshold may be determined according to different applications and not limited to those disclosed herein.

In the embodiment of the present disclosure, the operating pattern may include, for example, an accumulated number, an operating interval, an accumulated displacement, an average speed, an operating frequency and/or a pressing pressure, wherein the average speed may be obtained according to the accumulated displacement and the operating interval, and the operating frequency may be obtained according to the accumulated number and the operating interval, but the present disclosure is not limited thereto. The accumulated number, the operating interval and the accumulated displacement may be compared with the pattern threshold so as to determine whether to generate the warning signal Sw. That is, the adaptive warning time may be determined according to both the operating condition and the operating pattern. It should be mentioned that the present disclosure may determine the adaptive warning time according to a comparison result of comparing only one of the accumulated number, the operating interval and the accumulated displacement with the pattern threshold or comparing a combination of the accumulated number, the operating interval and the accumulated displacement with the pattern threshold.

The average speed, the operating frequency and/or the pressing pressure may represent an operating strength of the user and may be configured to adjust the pattern threshold determined by the current operating condition. For example, when the operating strength is higher, the user can feel tired easier such that it is able to adjust the determined pattern threshold so as to correspondingly change the warning time (illustrated by an example hereinafter). In addition, the accumulated number, operating interval, accumulated displacement and operating strength every time the user operating may be used to update the pattern threshold associated with the operating condition so as to form the individual operating condition. In other words, the pattern threshold associated with the operating condition may be related with the historical operating pattern of the user.

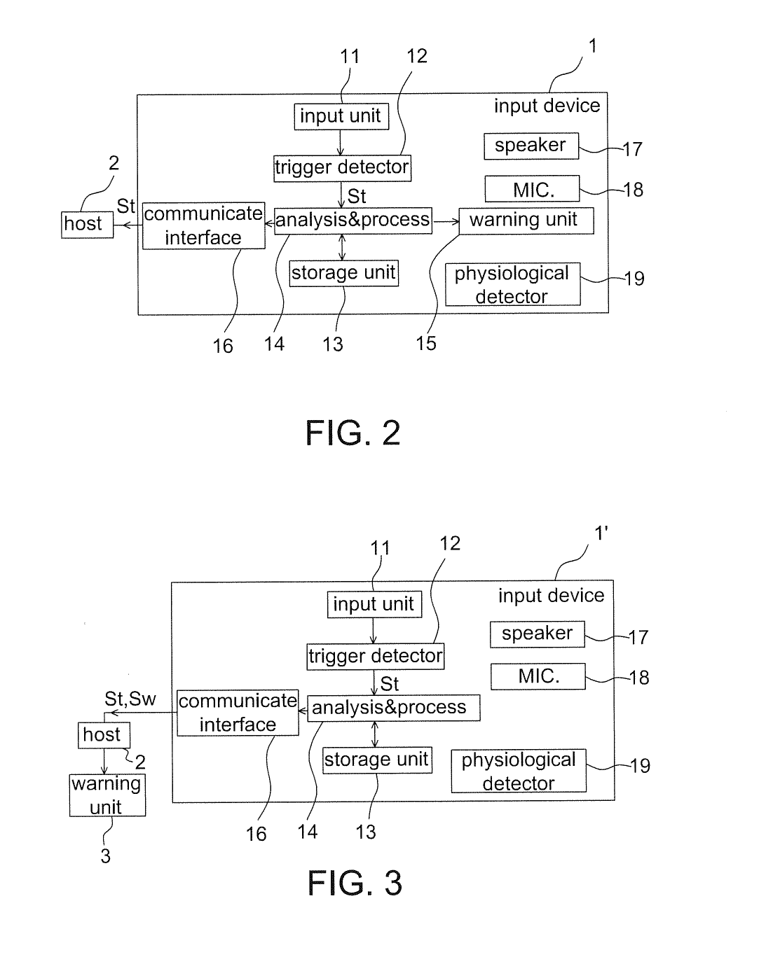

Referring to FIG. 2, FIG. 2 shows a schematic block diagram of the computer system according to an embodiment of the present disclosure, which includes an input device 1 and a host 2. In this embodiment, the input device 1 is simultaneously configured to detect trigger events of the user for outputting trigger signals St and to analyze the user's operating pattern for giving a warning at a warning time. The host 2 then executes a corresponding operation according to the trigger signals St. It is appreciated that the host 2 may perform different corresponding operations according to the trigger signals St of different input devices 1, e.g. a mouse device, a joystick device, a keyboard or a touchpad. In this embodiment, the analysis of the user's operating pattern and the warning are both performed by the input device 1. e.g. built in the input device 1 by hardware.

The input device 1 includes at least one input unit 11, a trigger detection unit 12, a storage unit 13, an analysis and processing unit 14, a warning unit 15 and a communication interface 16.

The input unit 11 is configured to input a plurality of trigger events by a user, wherein corresponding to different input devices 1 the input unit 11 may be a mouse button, a mouse roller, a joystick, a keyboard button or a touchpad. It is appreciated that a mouse device may include two mouse buttons, and a keyboard device may include a plurality of keyboard buttons. Accordingly, the input device 1 may include at least one input unit 11 according to different implementations.

The trigger detection unit 12 is configured to detect the trigger events of the at least one input unit 11 and generate a trigger signal St corresponding to each of the trigger events, wherein corresponding to different input devices 1 the trigger detection unit 12 may generate different trigger signals St. For example, when the input unit 11 is a mouse button, the trigger signal St may only include the left click information and the right click information; when the input unit 11 is a joystick, the trigger signal St may include information of the magnitude and the direction; when the input unit 11 is a touch pad, the trigger signal St may include information of the coordinate and the displacement; and when the input unit 11 is a mouse, the trigger signal St may include information of the displacement and the direction vector.

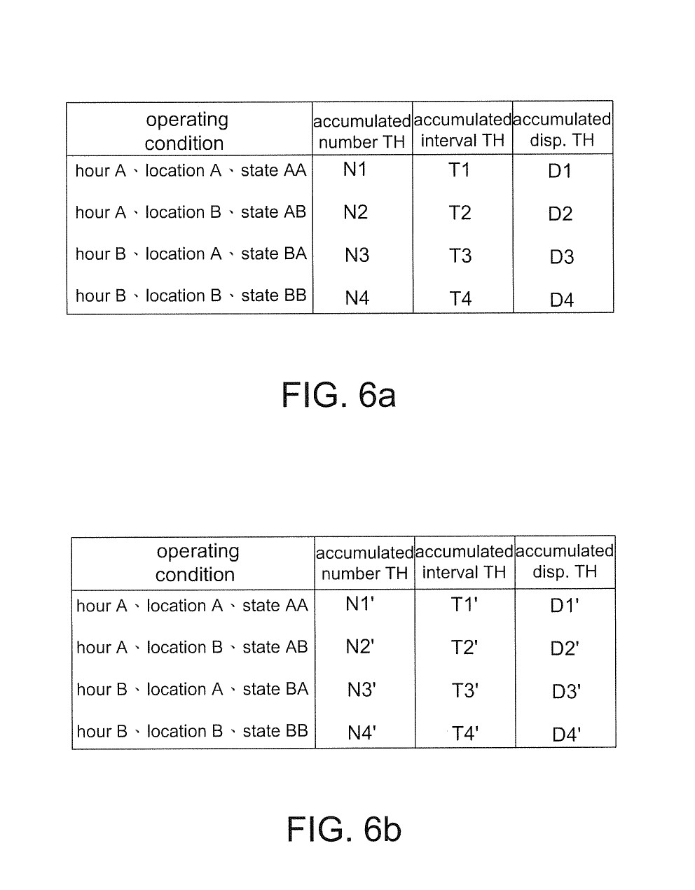

The storage unit 13 is configured to record an operating condition associated with the user. As mentioned above, as the operating condition is associated with different operating hours, different operating locations, different terminal devices, different application software and/or different operating states, the storage unit 13 may record pattern thresholds associated with different operating conditions, e.g. including an accumulated number threshold, an accumulated interval threshold and an accumulated displacement threshold (e.g. as shown in FIGS. 6a and 6b). For example, the operating condition and the pattern threshold may be constructed as a lookup table, and the lookup table may be continuously updated according to the user's operating pattern so as to form a personal lookup table. For example, a predetermined lookup table may be recorded in the storage unit 13 before shipment (e.g. as shown in FIG. 6a), and with the continuous operation of the user, the pattern threshold associated with every operating condition in the lookup table may be automatically updated according to the use habit of user so as to correspondingly change a warning time to give a warning (e.g. as shown in FIG. 6b), i.e. the warning time may be an adaptive warning time. In this embodiment, the lookup table may be gradually changed according to the operating pattern each time, e.g. different operating hours, different operating locations, different terminal devices, different application software and/or different operating states.

The analysis and processing unit 14 is configured to analyze an operating pattern of the trigger signals St and determine a warning time according to the operating condition and the operating pattern. As mentioned above, as the operating pattern may include an accumulated number, an operating interval, an accumulated displacement, an average speed, an operating frequency and/or a pressing pressure, the analysis and processing unit 14 may control the warning unit 15 to give a warning according to a comparison result of comparing the accumulated number, operating interval and accumulated displacement with the pattern threshold, and may real-timely adjust the pattern threshold determined by the operating condition according to an operating strength (e.g. the average speed, operating frequency and/or pressing pressure). For example, when the operating strength is stronger, the user can get tired easier such that the pattern threshold may be decreased accordingly thereby shortening the warning time. In addition, in the embodiment of the present disclosure as the lookup table may be trained to fulfill the personal requirement, the operating pattern may also be used to update the pattern threshold associated with every operating condition. In addition, the analysis and processing unit 14 may also perform the conventional operation of the input device 1, e.g. the displacement calculation of mouse device, the input function of keyboard device, the control function of joystick and so on. In other words, the analysis and processing unit 14 performs the function of the input device 1 itself and has the function of analyzing the operating pattern as well.

The warning unit 15 is controlled by the analysis and processing unit 14 so as to give a warning when reaching the warning time (e.g. the accumulated number reaching the accumulated number threshold, the operating interval reaching the accumulated interval threshold and/or the accumulated displacement reaching the accumulated displacement threshold), wherein the given warning may be different according to the type of the warning unit 15. For example, the warning unit 14 may be a speaker, a light source, a vibrator and so on, and the warning may be a sound, a lamp signal or a vibration, but not limited thereto. For example, the analysis and processing unit 14 may deactivate the activity of the trigger detection unit 12 to allow the user to feel the operation response being slowed down or stopped to be served as a warning.

The communication interface 16 may be a wired or wireless interface, and is configured to transmit the trigger signal St to the host 2 for performing corresponding operations, wherein the wired and wireless communication technologies are well known and thus details thereof are not described herein. In addition, when the input device 1 is connected to the host 2 with a cable line, the host 2 may charge the input device 1 through the cable line.

In one embodiment, the input device 1 may further include a speaker 17 and a microphone 18, and thus besides transmitting the trigger signal St, the communication interface 16 may also transmit audio signals. In this manner, the user may directly use the input device 1 to conduct the telephone conference so as to increase the practicality thereof. In addition, the speaker 17 may also be served as the warning unit 15 configured to generate the warning sound, to generate predetermined sound effect or to broadcast time.

In one embodiment, the input device 1 may further include a physiological detection unit 19 configured to recognize different users. For example, the physiological detection unit 19 may be configured to detect the specific fingerprint, pulse or sliding track so as to activate the input device 1 or access the lookup table associated with a current user, wherein the method of detecting the pulse may be referred to U.S. patent application Ser. No. 13/614,999 assigned to the same assignee of the present application, and the method of detecting the sliding track may be referred to U.S. patent application Ser. No. 13/869,368 assigned to the same assignee of the present application.

In one embodiment, the communication interface 16 of the input device 1 may output the trigger signal St to the host 2 with an adjustable report rate, wherein the report rate may be determined according to the application software currently executed by the host 2. For example, when the host 2 is executing the document processing software, the communication interface 16 may report the trigger signal St at a lower report rate so as to decrease the system consuming power, whereas when the host 2 is executing the game software, the communication interface 16 may report the trigger signal St at a higher report rate so as to shorten the response time. In addition, in one embodiment the analysis and processing unit 14 may decrease the report rate to allow the user to feel the lowered operating response to be served as a warning.

Referring to FIG. 3, it shows a schematic diagram of the computer system according to another embodiment of the present disclosure, which includes an input device 1′ and a host 2. The input device 1′ also includes the input unit 11, the trigger detection unit 12, the storage unit 13, the analysis and processing unit 14 and the communication interface 16. The difference between this embodiment and FIG. 2 is that in FIG. 3 the input device 1′ is only configured to analyze the user's operating pattern but does not include the warning unit. In other words, in this embodiment the warning unit 3 is arranged outside the input device 1′, e.g. disposed in the host 2 or coupled to the host 2 (e.g. the warning unit 3 shown to be separated from and coupled to the host 2 herein).

Accordingly, in this embodiment the analysis and processing unit 14 is configured to analyze an operating pattern of the trigger signals St and generate a warning signal Sw at an adaptive warning time according to the operating condition and the operating pattern. The communication interface 6 is then configured to wired or wirelessly transmit both the trigger signal St and the warning signal Sw to the host 2.

The host 2 then controls a warning unit 3 to give a warning according to the warning signal Sw. For example, the warning unit 3 may be a speaker, a screen device or a light source so as to generate different warning. In addition, the host 2 may perform a corresponding operation according to the trigger signal St, e.g. controlling a cursor. Therefore, the warning may be set as deactivating the corresponding operation (e.g. decreasing the moving sensitivity of the cursor) to be served as a type of warning. It is appreciated that the corresponding operation may be determined according to the type of the input device 1 and is not limited to the cursor motion.

In addition, in this embodiment the functions of the input unit 11, the trigger detection unit 12 and the storage unit 13 are similar to those of FIG. 2 and thus details thereof are not repeated herein. In addition, in this embodiment the input device 1′ may also further include a microphone 17, a speaker 18 and a physiological detection unit 19 and since they are similar to those of FIG. 2. details thereof are not repeated herein. The input device 1′ may also further have a data storage module to have the function of the flash disk. The input device 1′ may also report information to the host 2 with an adjustable report rate.

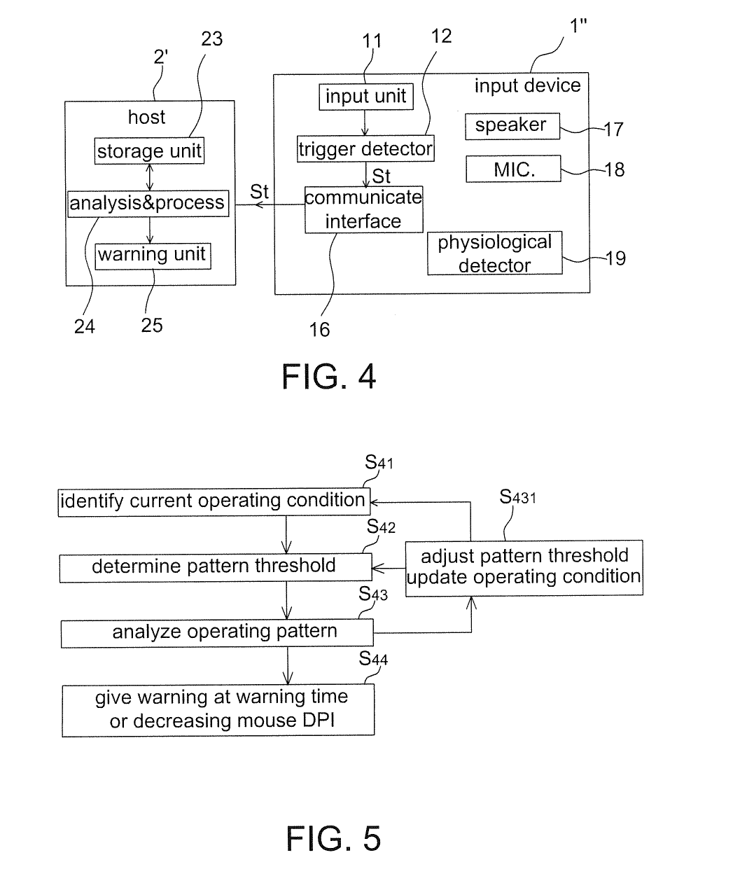

Referring to FIG. 4, it shows a schematic diagram of the computer system according to another embodiment of the present disclosure, which includes an input device 1″ and a host 2′. The input device 1″ also includes the input unit 11, the trigger detection unit 12 and the communication interface 16. The difference of this embodiment and FIG. 2 is that in FIG. 4 the input device 1″ is only configured to output the trigger signal St but does not analyze the user's operating pattern. More specifically speaking, functions of analyzing the operating pattern and giving a warning are both performed by the host 2′. Accordingly, the host 2′ may further include a storage unit 23, an analysis and processing unit 24 and a warning unit 25, wherein the storage unit 23 may be the memory of the host 2′ itself, and the analysis and processing unit 24 may be the CPU (central processing unit) of the host 2′. Similar to FIG. 2, the storage unit 23 is configured to record an operating condition associated with a user. The analysis and processing unit 24 is configured to analyze an operating pattern of the trigger signals and determine a warning time according to the operating condition and the user's operating pattern. The warning unit 25 may generate a warning through a speaker, a screen or a light source, or deactivate the corresponding operation of the host 2′ corresponding to the trigger signal St. In other words, in this embodiment the functions of the storage unit 13, the analysis and processing unit 14 and the warning unit 15 are moved to the host 2′, e.g. installed in the host 2′ by software. In addition, the warning unit 25 may not be included in the host 2′ (as shown in FIG. 3).

Referring to FIG. 5, it shows an operational flow chart of the embodiment of the present disclosure including the steps of: identifying a current operating condition (Step S₄₁); determining a pattern threshold (Step S₄₂); analyzing an operating pattern (Step S₄₃); adjusting the pattern threshold and updating the operating condition (Step S₄₃₁); and giving a warning at a warning time (Step S₄₄); wherein in the step S₄₃₁ the adjusting of the determined pattern threshold according to the operating pattern may not be implemented and only the updating of the operating condition according to the operating pattern is implemented. In addition, the flow chart shown in FIG. 5 may be applied to all the computer systems of FIG. 2 to FIG. 4. As mentioned above, the differences between FIG. 2 to FIG. 4 are in the device that performs the operating pattern analysis and gives the warning.

Step S₄₁: The analysis and processing unit 14 determines a current operating condition according to the information at system startup, e.g. including an operating hour, an operating location, a user ID, a terminal device, application software and/or an operating state, and the information of the operating condition is previously stored in the storage unit 13.

Step S₄₂: The analysis and processing unit 14 determines at least one pattern threshold, e.g. including an accumulated number threshold, an accumulated interval threshold and/or an accumulated displacement threshold, according to the operating hour, operating location, user ID, terminal device, application software and/or operating state as well as the lookup table. That is, now the pattern threshold is determined according to the historical operating pattern. For example, the analysis and processing unit 14 may have an application program (APP), wherein the APP may automatically detect the current operating condition or allow the user to select the current operating condition. For example, the operating hour may be determined according to the current clock time shown by the computer system; the operating location may be selected by the user; the user ID may be selected by the user him/herself or detected by the physiological detection unit 19; the terminal device may be selected by the user him/herself; the application software may be automatically detected by the analysis and processing unit 14; and the operating state may be a personal parameter.

Step S₄₃: The analysis and processing unit 14 analyzes an accumulated number, an operating interval and/or an accumulated displacement of the trigger signals St to be compared with the pattern threshold. For example, when the pattern threshold is an accumulated number threshold, the analysis and processing unit 14 may take the accumulated time threshold as a warning time. In addition, the warning time may also be determined according to a comparison result of comparing the accumulated number with the accumulated number threshold and/or comparing the accumulated displacement with the accumulated displacement threshold. It is appreciated that the analysis and processing unit 14 analyzes the accumulated displacement only when the mouse or touch pad is being used, but the analysis and processing unit 14 does not analyze the accumulated displacement when the keyboard or joystick is being used. In other words, the parameter contained in the operating pattern analyzed by the analysis and processing unit 14 is determined according to the input device 1.

Step S₄₃₁: In order to allow the input device and computer system according to the embodiment of the present disclosure to be adapted to different operating conditions, the analysis and processing unit 14 may further update the operating condition according to the operating pattern, e.g. updating the pattern threshold corresponding to the operating condition according to the operating strength. As mentioned above, the operating pattern may also be configured to update the pattern threshold corresponding to the operating hour, operating location, user ID, terminal device and/or application software. In addition, the operating strength may also be configured to adjust the current pattern threshold determined according to the Step S₄₁ such that the warning time may be more suitable to the current operating pattern. Accordingly, now the pattern threshold is determined according to both the historical operating pattern and the current operating pattern.

Step S₄₄: The analysis and processing unit 14 then controls the warning unit 3 to give a warning at the warning time or when the pattern threshold is satisfied. As mentioned above, the warning may be determined according to the type of the warning unit 15 (25) without particular limitation.

In addition, after the warning is generated and if the user continuously operates the computer system or input device 1, the analysis and processing unit 14 may stop analyzing but give the warning again every a predetermined time interval. Or the analysis and processing unit 24 may continuously analyze and give the warning again when a ratio (e.g. 50%) of the pattern threshold is satisfied, and the warning time may be gradually shortened.

Referring to FIGS. 6a and 6b, they show the operational schematic diagrams of the input device and the computer system according to the embodiment of the present disclosure. FIG. 6a shows a lookup table regarding the operating conditions versus pattern thresholds before shipment, and FIG. 6b shows a lookup table regarding the operating conditions versus pattern thresholds after training, wherein for simplification purpose FIGS. 6a and 6b only show a part of the operating conditions mentioned above.

For example in FIG. 6a, before shipment, under the operating condition of operating hour A, operating location A and operating state AA (e.g. associated with the operating strength), the pattern threshold includes at least one of the accumulated number threshold N1, the accumulated interval threshold T1 and the accumulated displacement threshold D1; under the operating condition of operating hour A, operating location B and operating state AB, the pattern threshold includes at least one of the accumulated number threshold N2, the accumulated interval threshold T2 and the accumulated displacement threshold D2; under the operating condition of operating hour B, operating location A and operating state BA, the pattern threshold includes at least one of the accumulated number threshold N3, the accumulated interval threshold T3 and the accumulated displacement threshold D3; and under the operating condition of operating hour B, operating location B and operating state BB, the pattern threshold includes at least one of the accumulated number threshold N4, the accumulated interval threshold T4 and the accumulated displacement threshold D4.

For example in FIG. 6b, after being used by the user, the pattern thresholds have been respectively updated as personal pattern thresholds according to the operating pattern each time the user operating. For example, under the operating condition of operating hour A, operating location A and operating state AA, the pattern thresholds are respectively changed to the accumulated number threshold N1′, the accumulated interval threshold T1′ and the accumulated displacement threshold D1′ according to the operating pattern each time the user operating, and other operating conditions are shown in FIG. 6b. For example, if the accumulated number of the user is mostly larger than N1, then N1′ may be larger than N1; if the operating interval of the user is mostly longer than T1, then T1′ may be longer than T1; and if the accumulated displacement of the user is mostly larger than D1, then D1′ m ay be larger than D1 so as to fulfill the individual use habits of the user. The operating state may be associated with the operating strength (e.g. including the average speed, the operating frequency and/or the pressing pressure) of the operating pattern each time the user operating.

In FIG. 6a, N1, N2, N3, N4 may be identical to or different from each other; T1, T2, T3, T4 may be identical to or different from each other; and D1, D2, D3. D4 may be identical to or different from each other. In FIG. 6b, N1′, N2′, N3′, N4′ may be identical to or different from each other; T1′, T2′, T3′, T4′ may be identical to or different from each other; and D1′, D2′, D3′, D4′ may be identical to or different from each other.

Referring to FIGS. 5 and 6a together, in actual operation the pattern threshold is determined according to the current operating condition at first, e.g. under the operating condition of operating hour A and operating location A, the pattern threshold being determined as at least one of the accumulated number threshold N1, the accumulated interval threshold T1 and the accumulated displacement threshold D1 (Steps S₄₁˜S₄₂). Next, the analysis and processing unit 14 (24) analyzes an operating pattern of the user and compares an accumulated number, an operating interval and/or an accumulated displacement with the pattern threshold so as to identify whether the warning time is reached (Step S₄₃). In addition, according to the operating pattern, e.g. comparing the average speed, operating frequency and/or pressing pressure with the operating state AA, so as to determine whether to adjust the pattern threshold determined in the Step S₄₂. For example, when the operating state is higher than the historical operating state AA (e.g. the current average speed higher than the historical average speed, the current operating frequency higher than the historical operating frequency and/or the current pressing pressure higher than the historical pressing pressure), the pattern threshold may be decreased so as to shorten the warning time; on the contrary, the pattern threshold may be increased so as to extend the warning time. Meanwhile, the operating pattern may also be used to update the pattern threshold corresponding to the operating hour A and the operating location A (Step S₄₃₁). Finally, the analysis and processing unit 14 (24) controls the warning unit 15 (25) to give a warning at the warning time. It is appreciated that the operating method under other operating conditions are similar and thus details thereof are not repeated herein. It should be mentioned that the operating conditions contained in the lookup table may be determined according to different applications and are not limited to those shown in the present disclosure. The increasing or decreasing of the operating condition corresponding to the operating threshold is only exemplary and not to limit the present disclosure.

In the embodiments of the present disclosure, the trigger detector 12 and the analysis and processing unit 14 are implemented by a microcontroller (MCU) or a central processing unit (CPU), and implemented by hardware and/or software without particular limitations.

Taking the input device 1 as a mouse device for example, the computer system of the present disclosure includes a mouse device 1, a computer host 2 and a display device 30, as shown in FIG. 1 for example. The display device 30 is an LCD display, OLED display, a plasma display, a projection device or the like, and is configured show a cursor 31 thereon for being moved/controlled by the mouse device 1. The computer host 2 is a desk computer, a notebook or the like, and is wired or wireless coupled to the mouse device 1, e.g., via a series interface. Bluetooth interface or the like. The computer host 2 is coupled to the display device 30 via a video interface, e.g., HDMI interface, DVI interface or the like. The communications between the computer host 2 and the display device 30 as well as the mouse device 1 are known to the art and thus details thereof are not described herein.

The mouse device 1 includes at least one mouse button (e.g., a left button and a right button), a mouse roller, a memory, a processor and a communication interface 16, wherein the mouse button and the roller are two examples of the input unit 11 mentioned above, the memory is an example of the storage unit 13 mentioned above, and the processor is an example of the analysis and processing unit 14 mentioned above. As mentioned above, the mouse device 1 is wired or wirelessly coupled to the computer host 2 via the communication interface 16.

The at least one mouse button is configured to generate a click signal when being operated; for example, when the left or right button is pressed once, a click signal is generated. The mouse roller is configured to generate a rolling signal when being operated; for example, when the mouse roller is rolled forward or backward by a step, a rolling signal is generated.

The memory is a volatile memory or nonvolatile memory, and is configured to store an operating condition. As mentioned above, the operating condition includes at least one of different operating hours, different operating locations, different application software and different user IDs, as shown in FIGS. 6a and 6b for example.

The processor is a microcontroller (MCU) or a central processing unit (CPU), and configured to analyze an operating pattern of a plurality of click signals and a plurality of rolling signals to determine an operating strain, determine a strain threshold according to the operating condition, and decrease a mouse DPI (dots per inch) when the operating strain exceeds the strain threshold. wherein the strain threshold is an example of the pattern threshold mentioned above. When the operating strain exceeds the strain threshold, it means that the user may feel tired.

In one embodiment, the operating pattern includes at least one of an accumulated operating number (e.g. within a predetermined time interval), an operating interval and an operating frequency, as shown in FIGS. 6a and 6b for example. More specifically, when the accumulated operating number (e.g. click numbers and/or rolling numbers) is higher, the operating strain is higher; when the operating interval (e.g. hours for playing games or working) is longer, the operating strain is higher; when the operating frequency (e.g. click frequency or rolling frequency) is faster, the operating strain is higher. Different operating conditions determine different strain thresholds, e.g., the accumulated number TH and accumulated interval TH shown in FIGS. 6A and 6B for example. When the operating strain exceeds the strain threshold, the processor decreases a mouse DPI, e.g., to ½ to 1/10 of the original DPI, to allow the user to easily feel a hint of high operating strain to be noticed that a break should be taken.

In one embodiment, the mouse device 1 itself adjusts the mouse DPI. In another embodiment, the mouse device 1 does not adjust the mouse DPI but generates a warning signal Sw to be sent to the computer host 2 external to the mouse device 1 via the communication interface 16 when the operating strain exceeds the strain threshold. The computer host 2 is configured to decrease a movement resolution of the cursor 31 (also referred to mouse DPI) shown on the display device 2 when receiving the warning signal Sw, e.g., to ½ to 1/10 of the original movement resolution of the cursor 31.

In some embodiments, the mouse device 1 includes an image sensor configured to successively output image frames. For example, FIG. 1 shows that the mouse device 1 includes a displacement detecting unit 10, wherein the displacement detecting unit 10 includes a light source and an image sensor. The light source is a light emitting diode or a laser diode, and the image sensor is a CCD image sensor, a CMOS image sensor or the like. The mouse device 1 is operated on a work surface S. The light source illuminates the work surface S and the image sensor receives reflected light from the work surface S to generate the image frames. For example in FIG. 1, the displacement detecting unit 10 is disposed in a housing of the mouse device 1, and the housing has an opening at a bottom surface thereof. The light source illuminates the work surface S through the opening, and the image sensor receives reflected light from the work surface S through the opening. The processor is further configured to calculate displacement according to the image frames, e.g. according to the correlation between image frames. In this embodiment, the operating pattern further includes at least one of accumulated displacement and an average speed. More specifically, when the mouse device 1 is moved more frequently or faster, the operating strain is higher. In some embodiments, the processor is further configured to recognize a user ID according to the image frames, e.g., by recognizing fingerprint or physiological characteristic. In this embodiment, the operating condition further includes different user IDs. More specifically, different users have different tolerance to the operating strain and the operating condition is different, It should be mentioned that the processor is able to recognize the user ID by other conventional ways rather than by optical detection,

As mentioned above, the operating condition stored in the memory of the mouse device 1 is changeable according to different conditions, as shown in FIGS. 6a and 6b. In this embodiment, the computer host 2 is further configured to update the operating condition stored in the memory of the mouse device 1 via the communication interface 16. For example, when the computer host 2 is started every time, the computer host 2 detects the operating condition at first (e.g. the day of time, user ID, location and so on) and updates the operating condition via the communication interface. Furthermore, when different software of the computer host 2 is executed, the computer host 2 is selectively to updates the operating condition via the communication interface 16, e.g. the gaming software corresponding to lower strain threshold. The method of detecting the location of computer host 2 is implemented, for example, by connecting the computer host 2 to the internet, which is known to the art, and thus details thereof are not described herein.

After the mouse DPI or the movement resolution of the cursor 31 is decreased, the mouse DPI or the movement resolution of the cursor 31 is recovered to its original value (before being decreased) after a predetermined time interval, e.g., 10-30 minutes. The predetermined time interval is a fixed value or is adjustable by the user. In some embodiments, the mouse DPI is recovered when the communication interface 16 receives a recovering signal from the external host 2. For example, the computer host 2 is further configured to control the display device 30 to show a warning message on the display device 30 via a graphic user interface (GUI) when receiving the warning signal Sw (i.e. when the operating strain exceeds the strain threshold). For example, the message is a pop-up message and the user only needs to move the cursor 31 on the message and click thereon, the message is disappeared and the computer host 2 recovers the movement resolution of the cursor 31 or sends the recovering signal to the mouse device 1 to recover the mouse DPI.

In some embodiments, the computer host 2 is further configured to control the display device 30 to show a warning message on the display device 3 via a graphic user interface when receiving the warning signal Sw (i.e. when the operating strain exceeds the strain threshold), and the mouse DPI or the movement resolution is recovered when the graphic user interface detects a predetermined interaction from the mouse device 1. For example, the warning message is specific instruction shown on the display device 30, e.g., a keyboard configuration or a continuous line, and the user has to follow the instruction to move the cursor 31 along the continuous line or click a number sequence on the keyboard configuration so as to recover the mouse DPI or the movement resolution of the cursor 31. If the GUI detects that the user does not follow the instruction well, it indicates that the operating strain of the user is not released enough and thus the mouse DPI or the movement resolution of the cursor 31 is not recovered. In some embodiments, the warning message is replaced by a simple computer game to test whether the operating strain of the user is released. More specifically speaking, if the user does not operate the mouse device 1 following the instruction of the warning message or the simple computer game is not finished, the mouse DPI or the movement resolution of the cursor 31 is not recovered.

In some embodiments, the computer host 2 is further configured to send a warning message to another computer terminal (e.g. via internet) or a portable device (e.g. a cellphone or PDA) when receiving the warning signal SW. In this way, parents can monitor the time for playing games of their children through the message being sent.

In other embodiments, the mouse device 1 does not calculate the operating strains but the computer host 2 calculates the operating strains. In this case, the processor of the mouse device 1 is only configured to analyze an operating pattern of a plurality of click signals and a plurality of rolling signals, and the communication device 16 of the mouse device 1 is configured to output the operating pattern. After receiving the operating pattern from the communication interface 16 of the mouse device 1, the host 2 determines an operating strain according to the received operating pattern, determines a strain threshold according to an operating condition, and decreases a movement resolution of the cursor 31 (also referred to mouse DPI) shown on the display device 30 when the operating strain exceeds the strain threshold. For example, the operations of the computer host 2 mentioned herein are executed by a microcontroller or a CPU, and are implemented by software and/or hardware without particular limitations. The computer host 2 also includes a memory for storing different operating conditions. The method of determining an operating strain according to the received operating pattern and determining a strain threshold according to an operating condition are mentioned above, and thus details thereof are not repeated herein.

In addition, in this embodiment, the computer system further includes a keyboard device, as shown in FIG. 1, wired or wirelessly coupled to the computer host 2. The computer host 2 is configured to determine the operating strain further according to a plurality of button signals sent from the keyboard device, for example one pressing of the button of the keyboard device generates a button signal. As mentioned above, the input device 1 is not limited to the mouse device and the keyboard device, the computer host 2 is able to determine the operating strain according to the operations of different input devices.

As mentioned above, the conventional input device can only output the control signal to correspondingly control a host or an electronic device connected thereto simply according to the user's operation, but cannot remind the user of the operation interval such that the overuse has always been a problem. Therefore, the present disclosure further provides an input device and a computer system (FIGS. 2-4) that may analyze and record the operating pattern according to different operating conditions, and determine a warning time and give a warning corresponding to different operating conditions and operating patterns to prevent the overuse problem.

Although the disclosure has been explained in relation to its preferred embodiment, it is not used to limit the disclosure. It is to be understood that many other possible modifications and variations can be made by those skilled in the art without departing from the spirit and scope of the disclosure as hereinafter claimed.

What is claimed is:

1. A mouse device comprising:
at least one mouse button configured to generate a click signal when being operated;
a mouse roller configured to generate a rolling signal when being operated;
a memory configured to store an operating condition; and
a processor configured to
analyze an operating pattern of a plurality of click signals and a plurality of rolling signals to determine an operating strain,
determine a strain threshold according to the operating condition, and
decrease a mouse DPI when the operating strain exceeds the strain threshold.

2. The mouse device as claimed in claim 1, wherein the operating condition comprises at least one of different operating hours, different operating locations, different application software.

3. The mouse device as claimed in claim 1, wherein the operating pattern comprises at least one of an accumulated operating number, an operating interval and an operating frequency.

4. The mouse device as claimed in claim 1, further comprising an image sensor configured to successively output image frames,
wherein the processor is further configured to calculate displacement according to the image frames, and the operating pattern further comprises at least one of accumulated displacement and an average speed.

5. The mouse device as claimed in claim 1, further comprising an image sensor configured to successively output image frames,
wherein the processor is further configured to recognize a user ID according to the image frames, and the operating condition comprises different user IDs.

6. The mouse device as claimed in claim 1, further comprising a communication interface configured to output a warning signal to an external host when the operating strain exceeds the strain threshold.

7. The mouse device as claimed in claim 6, wherein the communication interface is further configured to receive an updated operating condition from the external host.

8. The mouse device as claimed in claim 6, wherein the mouse DPI is recovered when the communication interface receives a recovering signal from the external host.

9. The mouse device as claimed in claim 1, wherein the mouse DPI is automatically recovered after a predetermined time interval.

10. A computer system comprising:
a mouse device comprising:
at least one mouse button configured to generate a click signal when being operated;
a mouse roller configured to generate a rolling signal when being operated;
a memory configured to store an operating condition;
a processor configured to analyze an operating pattern of a plurality of click signals and a plurality of rolling signals to determine an operating strain, determine a strain threshold according to the operating condition, and generate a warning signal when the operating strain exceeds the strain threshold; and
a communication interface configured to output the warning signal;
a display device configured to show a cursor; and
a computer host coupled to the mouse device via the communication interface and coupled to the display device via a video interface, and the computer host configured to decrease a movement resolution of the cursor shown on the display device when receiving the warning signal.

11. The computer system as claimed in claim 10, wherein the computer host is further configured to control the display device to show a warning message on the display device via a graphic user interface when receiving the warning signal, and the movement resolution is recovered when the graphic user interface detects a predetermined interaction from the mouse device.

12. The computer system as claimed in claim 10, wherein the movement resolution is automatically recovered after a predetermined time interval.

13. The computer system as claimed in claim 10, wherein the operating condition comprises at least one of different operating hours, different operating locations, different application software and different user IDs.

14. The computer system as claimed in claim 10, wherein the computer host is further configured to update the operating condition stored in the memory of the mouse device via the communication interface.

15. The computer system as claimed in claim 10, wherein the operating pattern comprises at least one of an accumulated operating number, an operating interval, accumulated displacement, an average speed and an operating frequency.

16. The computer system as claimed in claim 10, wherein the computer host is further configured to send a warning message to another computer terminal or a portable device when receiving the warning signal.

17. A computer system comprising:
a mouse device comprising:
at least one mouse button configured to generate a click signal when being operated;
a mouse roller configured to generate a rolling signal when being operated;
a processor configured to analyze an operating pattern of a plurality of click signals and a plurality of rolling signals; and
a communication interface configured to output the operating pattern;
a display device configured to show a cursor; and
a computer host coupled to the mouse device via the communication interface and coupled to the display device via a video interface, and the computer host configured to
determine an operating strain according to the received operating pattern,
determine a strain threshold according to an operating condition, and
decrease a movement resolution of the cursor shown on the display device when the operating strain exceeds the strain threshold.

18. The computer system as claimed in claim 17, further comprising a keyboard, wherein the computer host is configured to determine the operating strain further according to a plurality of button signals sent from the keyboard.

19. The computer system as claimed in claim 17, wherein the computer host is further configured to control the display device to show a warning message on the display device via a graphic user interface when the operating strain exceeds the strain threshold, and the movement resolution is recovered when the graphic user interface detects a predetermined interaction from the mouse device.
